(19) United States
(12) Patent Application Publication
(10) Pub. No.: US 2021/0093987 A1
(43) Pub. Date: Apr. 1, 2021

(54) PASSIVE SELF-CLEANING FILTRATION METHOD AND APPARATUS

(71) Applicant: Orenco Systems, Inc., Sutherlin, OR (US)

(72) Inventors: Eric S. Ball, Roseburg, OR (US); Terry R. Bounds, Roseburg, OR (US)

(73) Assignee: Orenco Systems, Inc., Sutherlin, OR (US)

(21) Appl. No.: 16/588,857

(22) Filed: Sep. 30, 2019

(51) Int. Cl. B01D 29/23; B01D 29/52; B01D 35/26; B01D 35/30; B01D 29/62; E03F 5/10

(52) U.S. Cl. CPC B01D 29/23; B01D 29/52; E03F 5/105; B01D 35/30; B01D 29/62; B01D 35/26

(57) ABSTRACT

A method and apparatus for passive self-cleaning filtration of a liquid containing suspended solids is disclosed. A filter assembly of upright cylindrical filter tubes having open, downwardly-facing ends is placed within a tank of unfiltered liquid. The filter assembly is positioned in the flow of liquid through the tank such that the unfiltered liquid must pass through the filter tubes prior to discharge from the tank. The inner walls of the filter tubes are smooth with small filtering holes. Unfiltered liquid is passes up into the filter tubes and the solids are collected in the tubes and on the smooth walls. Filtered liquid that has passed through the filter tubes is kept separated from the unfiltered liquid by a barrier that functionally prevents passage of unfiltered liquid. The filtered liquid is passed out of the tank. A filter housing protects the filtered liquid and the outside surface of the filter tubes from unfiltered liquid. The solids that have collected in the filter tubes and on the smooth inner walls of the filter fall out of the open, downwardly-facing ends of the filter tubes. The filter housing has a lower chamber below the filter assembly with a sloping floor and an opening for unfiltered liquid to enter the filter housing and accumulated solids to leave the housing. The sloping floor encourages solids that fall out of the filter tubes to move down the slope and out of the housing. The filter assembly may be raised at least partially out of the tank and cleaned by washing the solids down the inside walls of the filter tubes, onto the sloping floor, and back into the unfiltered liquid. The filter assembly may be associated with a pump which pumps filtered liquid from the tank.

### FIELD OF INVENTION

This invention relates to a method and apparatus for filtering a liquid containing suspended solids.

### BACKGROUND OF INVENTION

Domestic sewage wastewater having waste solids is often collected in a wastewater treatment container, such as a septic tank, for primary treatment. As the wastewater travels through the septic tank from the inlet to outlet, the solids resolve into an upper horizontal scum layer, a lower horizontal sludge layer, and an intermediate horizontal relatively “clear” layer of wastewater containing suspended solids. Suspended solids in the clear layer also include solids lifted from the sludge layer by gas bubbles created as part of the decomposition process and solids from the scum layer precipitating downwardly through the clear layer toward the sludge layer.

In gravity flow septic tanks, effluent wastewater from the clear layer is released from the tank in response to inflow of new wastewater. Often the wastewater is delivered to the tank in pulses with quiescent periods between the pulses. Typically the wastewater in the tank is maintained at a certain level or within a certain range. Wastewater delivered to the tank typically results in corresponding discharge from the tank. Discharging filtered wastewater is beneficial to downstream treatment such as a drainfield. In some cases it is necessary or preferable to pump the effluent from tank. In such cases the pump is often enclosed in a pump vault and wastewater from the clear layer is filtered prior to passing through the pump and out of the tank. The present invention relates to filtering liquids containing suspended solids.

The problem of filtering or screening solids from wastewater and the accompanying problem of removing the solids that are collected or lodged on the screen or filter has been a matter of interest to those in the wastewater treatment industry for some time. Examples of prior devices and methods in the wastewater treatment context may be seen in Ball, U.S. Pat. No. 4,439,323, Zabel, U.S. Pat. No. 4,710,295, and Ball, U.S. Pat. No. 5,492,635.

### BRIEF SUMMARY OF THE EXEMPLARY EMBODIMENT OF THE INVENTION

A filter vault with an impervious at least partially submersible housing is configured to permit wastewater containing suspended solids to enter the housing. A filter element positioned in the housing has a filtering surface that is exposed to unfiltered wastewater. An impervious barrier is arranged to create within the housing an upper chamber. The first barrier cooperates with said housing to functionally prevent passage of unfiltered wastewater into said upper chamber. The first barrier has a first aperture cooperating with a filter element to functionally prevent passage of the unfiltered wastewater into said upper chamber except through the filter element.

### BRIEF DESCRIPTION OF THE DRAWINGS

FIG. 1 is a perspective view of an exemplary filter vault embodying the present invention.

FIG. 2 is a perspective view of a filter assembly including multiple filter elements.

FIG. 3 is a sectional view of the filter assembly of FIG. 2 taken along lines 3-3.

FIG. 4 is a sectional view of the filter vault of FIG. 1 taken along lines 4-4 of FIG. 1

FIG. 5 is a partial sectional view of the filter vault and filter assembly of FIG. 4 including two exemplary filter elements showing the flow of wastewater from the clear layer through the filter elements and out of the filter assembly.

FIG. 6 is a partial sectional view of an alternative embodiment of the filter vault and filter assembly, including two exemplary filter elements showing the flow of wastewater through the filter elements, and out of a filter chamber.

### DETAILED DESCRIPTION OF THE EXEMPLARY EMBODIMENT

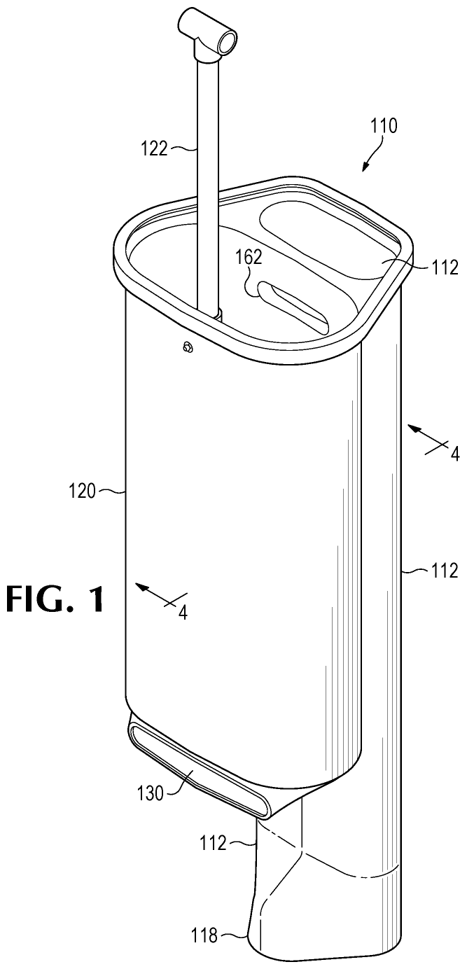

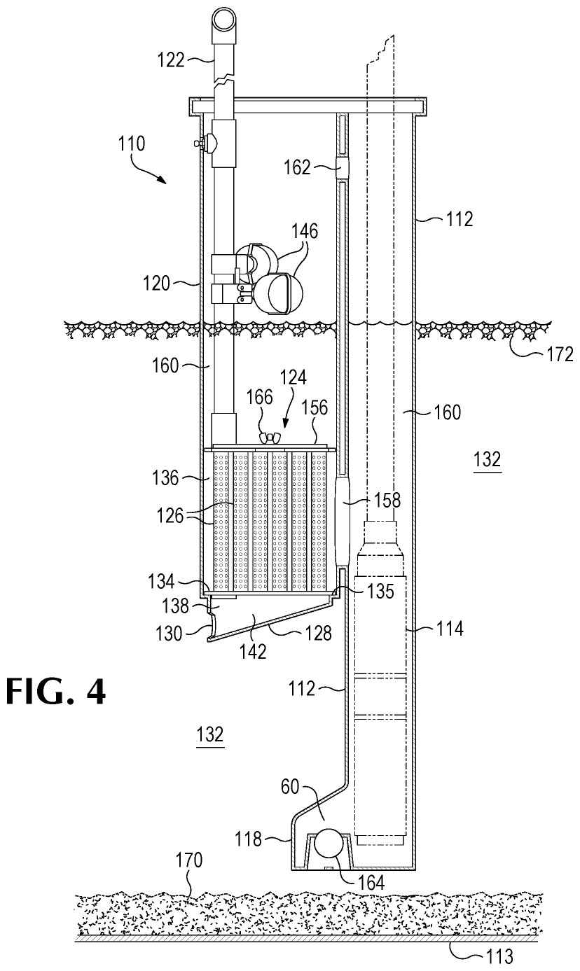

Referring to FIGS. 1 and 4, a filter vault 110 is shown in combination with a pump closet 112 enclosing an effluent pump 114. The pump closet 112 includes a foot 118 enclosing a ball valve 164. The filter vault 110 includes an impervious filter housing 120 at least partially enclosing a float tree 122 supporting float switches 146 on pivotable arms 148, and a filter assembly 124, including multiple filter elements in the form of filter tubes 126. The filter housing 120 has a sloping floor 128 and an inlet 130 for permitting unfiltered wastewater 142 from the “clear” layer 132 of the wastewater to enter into the filter housing 120. As will be described below, the inlet 130 also serves as a discharge portal for suspended solids.

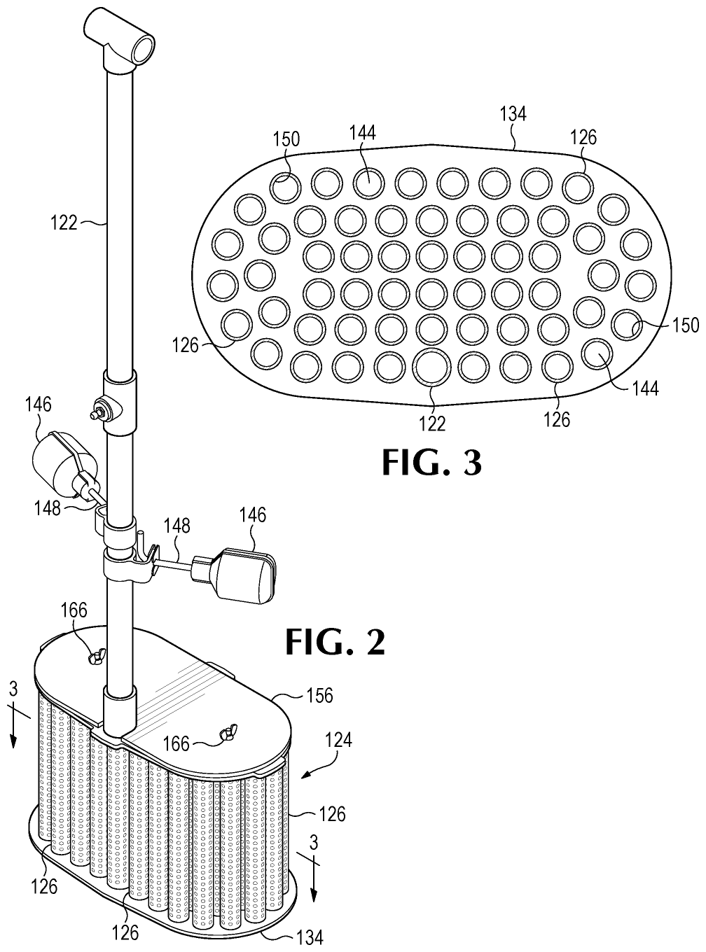

Referring to FIGS. 2-5, the filter assembly 124 includes an impervious first barrier 134. The first barrier 134 rests on a ledge 135 on the inner circumference of the filter housing 120 to create, within the filter housing 120, an upper chamber 136 above the first barrier 134 and a lower chamber 138 below the first barrier 134. The first barrier 134 also functions as a base for the filter assembly 124 and supports a plurality of upright, elongate filter tubes 126 above the first barrier 134. In this exemplary embodiment each filter tube 126 has an upright wall defining an interior space 144 within the filter tube 126. The upright wall is perforated with multiple filtering holes 154. The inner surface of the filter tube 126 serves as a filtering surface 150. Except for the filtering holes 154, the filtering surface 150 is smooth to discourage accumulation of solids from the unfiltered wastewater 142 on the filtering surface. A smooth surface also makes it easier for the solids to fall off the filtering surface 150 and through the open bottoms 152 of the filter tubes 126. The first barrier 134 has a plurality of apertures 140 matching the number of filter tubes 126. The bottoms 152 of the filter tubes 126 are open and are fitted or attached to the apertures 140 in the first barrier 134 to permit passage of unfiltered wastewater 142 into and out of the filter tubes 126.

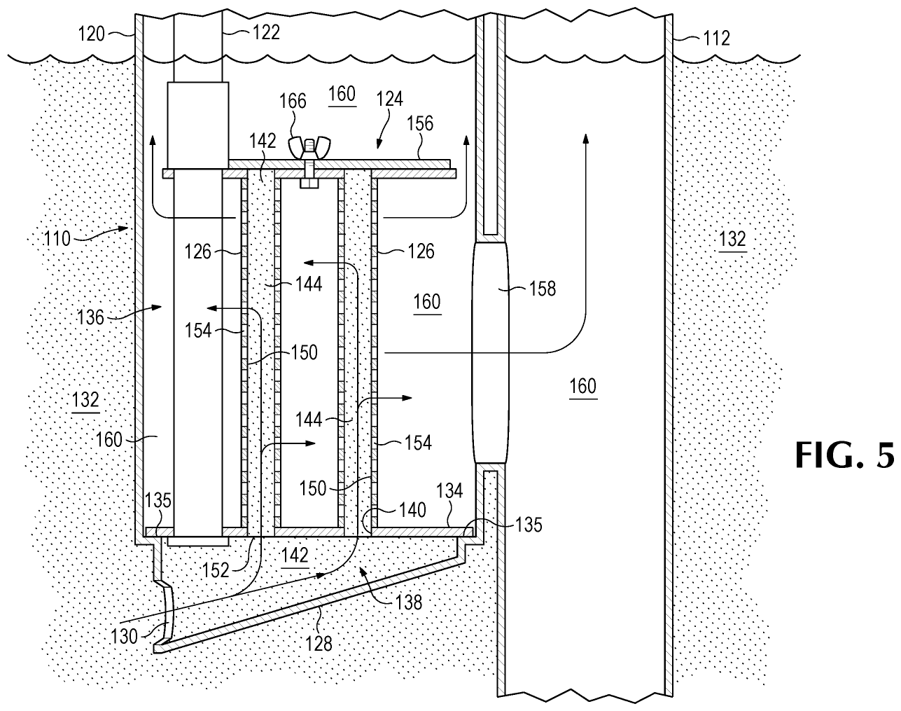

As may be seen in FIG. 5, the open bottoms 152 of the filter tubes 126 face the sloping floor 128 such that the interior space 144 and smooth filtering surface 150 of the filter tubes 126 are exposed to unfiltered wastewater 142 having suspended solids (represented by the small dots) from the clear layer 132. The sloping floor 128 lies directly beneath the interior space 144 and the filtering surface 150 with no intervening structure between the open bottom 152 of the filter tube 126 and the sloping floor 128. Solids which are collected in the interior space 144 of the filter tubes 126 or lodged on the smooth filtering surface 150 are free to settle directly downwardly to the sloping floor 128 and migrate to an exit portal, which in the exemplary embodiment also serves as the inlet opening 130.

As seen in FIGS. 2, 4 and 5, the filter assembly 124 also includes a lid 156 which sits atop and covers the open tops of the filter tubes 126, functionally preventing unfiltered wastewater 142 from passing into the upper chamber 136 except through the filter holes 154 in the filtering surface 150 of the filter tubes 126. Accordingly, in the exemplary embodiment all wastewater above the first barrier 134 is filtered wastewater 160, having passed through the filtering holes 154 substantially reducing the size and number of suspended solids. Referring to FIGS. 4 and 5, there is a passageway 158 leading out of the upper chamber 136 and into the pump closet 112 enabling the filtered wastewater 160 to be pumped out of the septic tank 113. In a system that does not employ a pump 114, the filtered wastewater from the upper chamber 136 is discharged from the tank 113 for further treatment.

Operation of the exemplary embodiment of the filter vault 110 is shown in FIG. 5. The pump 114, not shown in FIG. 5, draws filtered wastewater 160 from the upper chamber 136, into the pump closet 112 through passageway 158 and pumps it out of the septic tank 113. Operation of the pump 114 creates a negative pressure in the upper chamber 136 drawing unfiltered wastewater 142 from the clear layer 132 into the lower chamber 138, up into the filter tubes 126 and through the filter holes 154 in the filtering surface 150. Suspended solids are collected in the filter tubes 126 and sometimes lodge on the smooth filtering surface 150. When the suspended solids collected in the filter tubes 126 and on the filtering surface 150 coalesce to a sufficient mass, the suspended solids are drawn by gravity out of the open bottom 152 of the filter tube 126, onto the sloping floor 128 and then out of the lower chamber 138 through the inlet/portal 130.

When the pump 114 ceases to draw filtered wastewater 160 from the upper chamber 136, unfiltered wastewater 142 with suspended solids is no longer drawn up into the filter tubes 126, and solids collected in the filter tubes 126 and on the filtering surface 150 are more likely to be drawn by gravity out of the filter tubes 126, down onto the sloping floor 128 and out the portal/inlet 130. Note that there are no intervening structures between the open bottoms 152 of the filter tubes 126 and the sloping floor 128 to interfere with solids falling to the floor 128.

In a gravity tank where there is no pump 114, the inflow of unfiltered wastewater into the tank creates a slight positive pressure on the upstream side of the filtering surface 150, drawing unfiltered wastewater 142 into the interior space 144 of the filter tubes 126, against the filtering surface 150, through the filtering holes 154, into the upper chamber 136 as filtered wastewater 160 and then out of the upper chamber 136 to a discharge port. As described above, suspended solids collect in the filter tubes 126, on the upstream side of the filtering surface 150 and eventually fall out of the open bottom 152 of the filter tube 126 and down onto the floor 128 of the filter housing 120. Introducing unfiltered wastewater 142 into the tank in pulses, such as occurs in a normal septic system, affords a quiescent period between pulses when there is no positive pressure on the upstream side of the filtering surface 150 and the collected solids are more likely to fall out of the filter tubes 126 and onto the floor 128.

Even though the passive self-cleaning aspect of the filter vault is effective to control the accumulation of suspended solids on the filtering surface 150, it might be beneficial to clean the filter assembly 124 occasionally for maximum efficiency. Referring to FIGS. 1 and 4 the pump vault 110 may be lifted wholly or partially out of the septic tank 113 using a handle 162 formed in the walls separating the filter housing 120 and pump closet 112. The filter housing 120 protects the filter assembly 124 and float switches 146 from contact with the accumulated material in the scum layer 172. The foot 118 of the pump closet 112 has a ball valve 164 which permits filtered wastewater 160 in the pump closet 112 to drain out of the pump closet 112 to facilitate access to the pump 114. Filtered wastewater 160 in the upper chamber 136 can drain into the lower chamber 138 through the filtering surface and filtered and unfiltered wastewater 142 in the lower chamber 138 of the filter housing 120 may drain into the tank 113 through the inlet/portal 130. Reverse flow of the filtered wastewater 160 through the filtering surface 150 can flush collected solids out of the filter tubes 126. As shown in FIGS. 2, 4, and 5 the cover 156 of the filter assembly 124 is held over the filter tubes 126 by easily accessible fasteners 166. Removing the cover 156 exposes filtering surface 150 inside the filter tubes 126. Using a stream of water or mechanical tools, the smooth filtering surface 150 of the filter tubes 126 may be easily cleaned of accumulated solids which will then fall into the lower chamber 138, off the sloping floor 128, and out the inlet/portal 130.

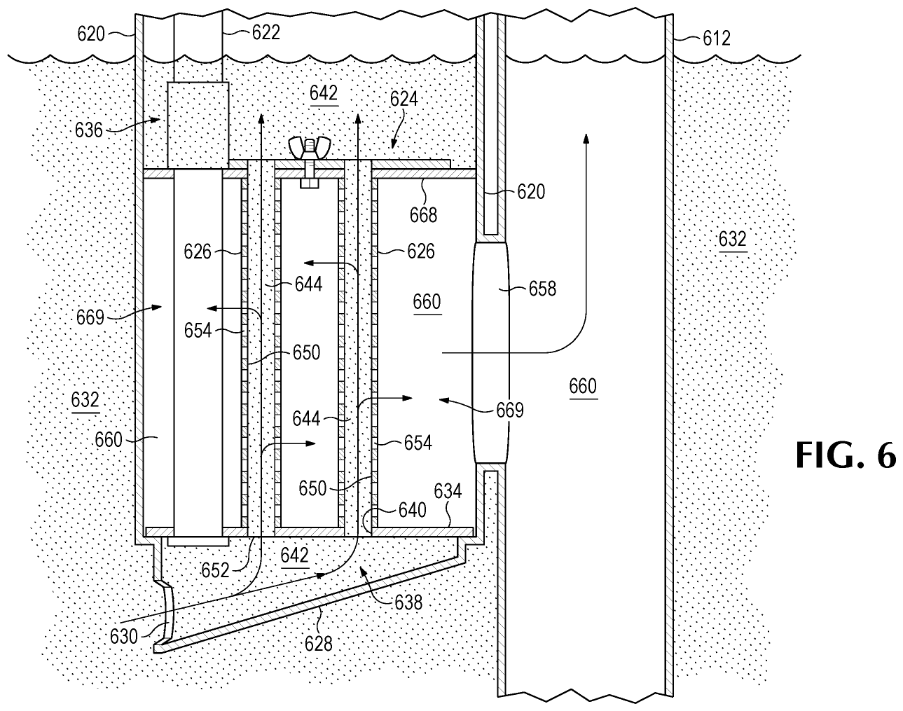

The alternative embodiment shown in FIG. 6 is also passively self-cleaning, but is easier to clean. As with the exemplary embodiment, the filter housing 620 of the alternative embodiment also includes a first barrier 634 creating within said filter housing 620 an upper chamber 636 and a lower chamber 638. The first barrier 634 supports two exemplary filter tubes 626. Like the prior exemplary embodiment, the filter tubes 626 have open bottoms 652, which are fitted to apertures 640 in the first barrier 634. These filter tubes 626 also include an interior space 644, an upright wall including a smooth filtering surface 650, and open bottoms 652 facing a sloping floor 628. However, unlike the exemplary embodiment show in in FIGS. 1-5, the tops of the filter tubes 626 are uncovered. Unfiltered wastewater 642 from the clear layer 632 is permitted to pass upwardly into the upper chamber 636. A second barrier 668 fits to the tops of the filter tubes 626 and is snug to the walls of the filter housing 620 to create, between the first barrier 634 and the second barrier 668 a functionally closed filter chamber 669 in fluid connection with the pump closet 612 through the passageway 658. Only filtered wastewater 660 which has passed through the filtering holes 654 of the filtering surface 650 is permitted into filter chamber 669 and through the passageway 658.

Operation of the alternative embodiment is similar to the first embodiment in that operation of the pump 614, not shown in FIG. 6, creates a negative pressure in the filter chamber 669 drawing unfiltered wastewater 642 with suspended solids up into the filter tubes 626 and through the filter holes 654 creating a reservoir of filtered wastewater 660 in the filter chamber 669. Like the exemplary embodiment, when the pump 614 is not drawing filtered wastewater 660 from the filter chamber 669, the suspended solids are no longer pulled toward the filtering surface 650, and tend to fall out the open bottom 652 of the filter tubes 626 onto the sloping floor 628 and out of the lower chamber 638 through the inlet/portal 630.

Similarly in a situation without a pump 614, pulsed inflow of unfiltered wastewater 642 creates periods of increased pressure on the upstream side of the filtering surface 650, and periods of equal pressure when solids collected in the filter tube 626 and on the filtering surface 650 are more likely to be pulled by gravity toward the sloping floor 628.

A feature of the second embodiment is that it is easier to clean. Once the filter housing 620 is pulled at least partially out of the unfiltered wastewater 642 in the septic tank 613, the filtering surfaces 650 of the filter tubes 626 are exposed may be cleaned by a stream of water or mechanical means without having to unfasten or remove a cover.

In FIG. 6, first barrier 634 and second barrier 668 create within in the filter housing 620 three separate chambers, a lower chamber 638, an upper chamber 636, and a filter chamber 669. The juncture between the housing 620 and the first and second barriers 634, 668 does not have to be watertight, but it should be sufficiently tight to functionally prevent passage of unfiltered wastewater 642 having solid particles larger than the filtering holes 654. As used in this application, “functionally preventing passage of unfiltered wastewater” means that particles larger than the filtering holes 654 in the filtering surface 650 will not pass. Similarly, the junction between the filter tubes 626 and the first and second barriers 634, 668 must functionally prevent passage of unfiltered wastewater 642 having solids larger than the filtering holes 654 in the filtering surface 650. The same is true with respect to the exemplary embodiment in FIGS. 2-5. The juncture of the first barrier 134 with the filter housing 120, and the juncture of the first barrier 134 and filter tubes 126 must functionally prevent passage of unfiltered wastewater 142. It is preferable that the fit between the barriers 134, 634, 668 and the filter housing 120, 620 permits the filter assembly 124, 624 to be lifted out of the filter housing 120, 620 for cleaning, repair, or replacement of the filter assembly 124, 624

Although the present invention is shown and described in the context of a septic tank with effluent pump, the invention relates to any wastewater container containing suspended solids. The filtering apparatus and method described herein is suitable for wastewater containers that do not use a pump.

Although the embodiments shown herein are described as the exemplary embodiment and the alternative embodiment, it should be understood that there may be more embodiments that manifest the present invention.

Although the exemplary filter element is shown as an upright cylindrical tube 126 with the entire inner tube wall acting as a filtering surface 150 the invention is not so limited. The filter element may be of many shapes; frustoconical for example, and it is not required that the entire inner surface operate as a filtering surface 150.

Although the present invention is described with a lower chamber 138 having an inlet opening 130 in the filter housing 120, a lower chamber 138, a floor 128, and inlet opening 130 are not necessary for passive self-cleaning operation.

While the foregoing is directed toward exemplary embodiments of the present invention, other and further embodiments of the invention may be devised without departing from the scope thereof which is defined by the claims.

1. A filter vault for use in a wastewater tank of the type having unfiltered wastewater containing suspended solids, said filter vault comprising:
a. an at least partially impervious and at least partially submersible filter housing is configured to permit said unfiltered wastewater to enter said housing;
b. a first filter element positioned within said housing, said first filter element having a filtering surface that is exposed to said unfiltered wastewater;
c. an impervious first barrier arranged to create within said housing an upper chamber, said first barrier cooperating with said housing to functionally prevent passage of said unfiltered wastewater into said upper chamber;
d. said first barrier having a first aperture cooperating with said first filter element to functionally prevent passage of said unfiltered wastewater into said upper chamber except through said first filter element.

2. The filter vault of claim 1 wherein said first barrier creates within said housing a lower chamber below said first barrier.

3. The filter vault of claim 2 further including an inlet opening in said lower chamber.

4. The filter vault of claim 1, wherein said lower chamber includes a floor, said filtering surface of said first filter element arranged above and exposed to said floor.

5. The filter vault of claim 4 wherein said first filter element defines an interior space with an open bottom facing said floor, said open bottom permitting said unfiltered wastewater containing said solids into said interior space and into contact with said filtering surface of said first filter element;

6. The filter vault of claim 1 wherein said filtering surface is substantially smooth.

7. The filter vault of claim 1 wherein said filtering surface is upright and has multiple small filtering holes therein.

8. The filter vault of claim 1 wherein said first filter element is an upright filter tube.

9. The filter vault of claim 7 wherein said filtering surface is smooth except for said filtering holes.

10. The filter vault of claim 5 wherein said open bottom permits said solids to fall downwardly out of said interior space.

11. The filter vault of claim 5, wherein said open bottom is below said filtering surface so as to permit said solids to fall from said filtering surface through said open bottom.

12. The filter vault of claim 4 wherein said floor slopes downwardly toward a portal into said tank.

13. The filter vault of claim 1 including a pump.

14. The filter vault of claim 1 wherein said first filter element has an open top permitting said unfiltered wastewater into said upper chamber.

15. The filter vault of claim 1 wherein said first filter element has an open top substantially closed by a removable cover that functionally prevents passage of said unfiltered wastewater into said upper chamber.

16. The filter vault of claim 15 wherein removing said cover provides access to said filtering surface from above.

17. The filter vault of claim 1 including a pump closet containing a pump in fluid connection with said upper chamber.

18. The filter vault of claim 14 further including an impervious second barrier creating within said upper chamber, a filter chamber between said first barrier and said second barrier, said second barrier cooperating with said housing to functionally prevent said unfiltered wastewater from said upper chamber to enter into said filter chamber.

19. The filter vault of claim 18 wherein said second barrier includes an aperture cooperating with said top of said first filter element to functionally prevent passage of said unfiltered wastewater into said filter chamber.

20. A method of treating unfiltered wastewater having suspended solids therein comprising:
a. at least partially immersing an at least partially impervious filter housing into a container of said unfiltered wastewater;
b. providing a substantially impervious first barrier to create within said housing an upper chamber above said first barrier and a lower chamber below said first barrier;
c. providing a first filter element having a filtering surface and an open bottom beneath said filtering surface, exposing said filtering surface to said unfiltered wastewater, and providing said first barrier with a first aperture to cooperate with said open bottom of said first filter element to functionally prevent passage of said unfiltered wastewater into said upper chamber;
d. flowing said unfiltered wastewater containing said solids upwardly into said first filter element causing said solids to be collected in said first filter element; and
e. permitting said solids collected in said first filter element to fall out of said open bottom of said first filter element.

21. The method of claim 20 including providing a lower chamber within said housing below said first barrier, said lower chamber including an inlet opening to permit said unfiltered wastewater into said lower chamber.

22. The method of claim 20 including providing said lower chamber with a floor below said filter element such that said filtering surface is exposed to said floor.

23. The method of claim 21 including providing a portal in said lower chamber and arranging said floor to slope toward said portal.

24. The method of claim 20 including providing said first filter element with at least one substantially upright filtering surface having multiple small openings therein.

25. The method of claim 20 including providing said first filter element with an open top.

26. The method of claim 25 including the step of at least partially raising said housing out of said container of wastewater exposing at least a portion of said filtering surface.

27. The method of claim 26 including removing solids from said filtering surface.

28. The method of claim 25 including providing a removable cover for said open top.

29. The method of claim 28 including the step of removing said cover and exposing said filtering surface.

30. The method of claim 29 including removing solids from said filtering surface.

31. The method of claim 25 including providing a second barrier to create within said housing a filter chamber between said first barrier and said second barrier.

32. The method of claim 31 including providing said second barrier with a first aperture that fits said open top of said first filter element.

33. A filter assembly for use in a container of unfiltered wastewater carrying suspended solids, said filter assembly comprising:
a. a first filter element defining an interior space and having a filtering surface with multiple discrete filtering holes therein, said first filter element having an open bottom beneath said filtering surface;
b. an impervious base supporting said first filter element above said base, said base having a first aperture adapted to closely fit to said open bottom of said first filter element without blocking said open bottom;
c. said first filter element having an open top with a removable cover over said open top so as to functionally prevent passage of said unfiltered wastewater through said open top.

34. The filter assembly of claim 33 further including a housing for said filter assembly, said housing adopted to fit closely to said base.

35. A filter assembly for use in a container of unfiltered wastewater carrying suspended solids, said filter assembly comprising:
a. a first filter element defining an interior space, said first filter element having a filtering surface with multiple discrete filtering holes therein, said first filter element having an open bottom beneath said filtering surface and an open top above said filtering surface;
b. an impervious base supporting said first filter element above said base, said base having an aperture adapted to closely fit closely to said open bottom of said first filter element without blocking said open bottom;
c. an impervious cover having aperture adapted to closely fit around said open top of said first filter element without blocking said open top.

36. The filter assembly of claim 35 further including a housing for said filter assembly, said housing adapted to fit closely with said base and said cover.
